(19) United States
(12) Patent Application Publication
(10) Pub. No.: US 2004/0233391 A1
(43) Pub. Date: Nov. 25, 2004

(54) Method for laser projection of images and a laser projector

(76) Inventors: Alexei Fyodorovich Kornev, St Petersburg (RU); Vassiliy Petrovich Pokrovskiy, St Petersburg (RU); Leonid Nikolayevich Soms, St Petersburg (RU); Vladimir Konstantinovich Stupnikov, St Petersburg (RU)

Correspondence Address: Iandiorio & Teska, 260 Bear Hill Road, Walthan, MA, 02451-1018, US

(21) Appl. No.: 10/486,773

(22) PCT Filed: Jun. 18, 2003
(86) PCT No.: PCT/GB03/02638

(30) Foreign Application Priority Data
Jun. 19, 2002 (RU) 200116304

(51) Int. Cl. G03B 21/00

(52) U.S. Cl. 353/31

(57) ABSTRACT

A method for the laser projection of images includes the supply of optical pump radiation to the active element of the laser in order to generate laser radiation, the spatial modulation of the laser radiation intensity by the image being projected, and the projection of spatially modulated laser radiation on the screen. In order to improve the laser projector efficiency and the brightness of the image being projected, at a sufficiently low “black level”, the spatial modulation of the laser radiation intensity is carried out by means of spatial modulation of the power of optical pump radiation being supplied on an active element of the laser. The laser projector for projecting images contains an optical pump source for the pump radiation generation, a spatial light modulator, and a laser resonator including a spectral selective element for the input of pump radiation inside the resonator, an active element located inside the laser resonator and means for the output of laser radiation from the resonator being generated therein. The spatial light modulator is located outside the laser resonator between the optical pump source and the spectral selective element of the laser resonator and is optically conjugated with the active element located inside the laser resonator.

The invention relates to laser engineering and, more especially, this invention relates to methods for laser projection of images, and to laser devices designed for image projection on screens.

A number of methods are known for the laser projection of images on screens. Such methods may be used, for example, in simulators or other systems reproducing the virtual reality. According to U.S. Pat. No. 5,704,700, the image projection is carried out by directing laser radiation to a screen. The laser radiation is generated by a micro-laser matrix and passed through a spatial light modulator located between the micro-laser matrix and the screen. The spatial light modulator generates the image being projected by the establishment of the required spatial distribution of the laser radiation intensity. However the existing spatial modulators, even in a fully closed state, transmit a certain amount of incident light, which determines the minimal possible level of screen illuminance and which is known as “black level”. As a result, the ratio between the maximum light transmission factor and the minimum transmission factor in existing spatial modulators does not as a rule, exceed a magnitude of 500-1000. Such a dynamic range in laser projectors can be insufficient, for example when a realistic imitation of night scenes is required.

In U.S. Pat. No. 6,088,380, an intra-resonator method is disclosed for the laser projection of images. The intra-resonator method includes the supply of optical pump radiation to an active laser element in order to generate laser radiation, spatial modulation of the laser radiation intensity formed by the active element, and the projection of the spatially modulated laser radiation onto a screen. The spatial modulation of the laser radiation intensity is carried out by means of a spatial light modulator located inside a laser resonator. The spatial light modulator located inside the laser resonator contributes additional losses into the resonator spatially modulated by the image being formed. The spatial distribution of the intensity of radiation generated by the laser corresponds to the spatial distribution of losses introduced to the resonator by the light modulator, which provides generation of the required image on the projection screen.

The laser projector designed for projecting images in accordance with the known method according to U.S. Pat. No. 6,088,380 contains an optical pump source for the generation of pump radiation, a spatial light modulator and a laser resonator including a spectral selective element for the input of pump radiation inside the resonator, an active element located inside the laser resonator, and facilities for the output of laser radiation from the resonator being generated therein. The spatial light modulator is located inside the laser resonator.

The location of a spatial modulator inside the laser resonator allows the full suppression of the generation of laser radiation from any separate laser resonator area by means of switching to a minimal light transmission state of the corresponding spatial modulator pixels which are optically conjugate with this area. This provides a practically zero “black level” in the image being projected.

However, the location of the spatial modulator inside the laser resonator leads to a considerable decrease of the laser efficiency. This is due to the introduction of initial losses into the laser being determined by the transmission factor of the spatial light modulator in the open state. These losses in real modulators cannot be made equal to zero, as they are determined both by light reflections from a large number of the surfaces of layers comprising the modulator (substrates, conducting layers, the modulating layer) and by light absorption in these layers.

In addition, the laser radiation power density which a typical spatial light modulator can endure without destruction, is essentially less that the limiting power density which is typical for other laser resonator elements, for example mirrors, active elements, polarisers, etc. Therefore, the positioning of the spatial modulator inside the laser resonator considerably restricts the maximum output power of laser radiation.

An aim of the present invention is to create a method and laser projector for the laser projection of images, in which the spatial modulation of laser radiation is carried out in order to provide a decrease of the minimum possible level of the screen illuminance, without the introduction of considerable losses into the laser resonator, and without a significant increase of the radiator power intensity acting on the spatial modulator, thereby securing an increase of the laser projector efficiency and the brightness of the image being projected by it, with a sufficiently low “black level” being provided.

Accordingly, the present invention provides a method of laser projection of images, which method comprises supplying optical pump radiation on an active element of a laser in order to generate laser radiation, spatially modulating of the intensity of laser radiation being generated by the active element by the image being projected, and projecting spatially modulated laser radiation onto a screen, characterised in that the spatial modulation of the laser radiation intensity is carried out by means of the spatial modulation of the power of optical pump radiation being supplied to the active element of the laser.

The present invention also provides a laser projector for projecting images, which laser projector comprises a optical pump source for the generation of pump radiation, a spatial light modulator, a laser resonator including a spectral selective element for the input of pump radiation inside the laser resonator, an active element located inside the laser resonator, and means for the output of laser radiation from the laser resonator being generated therein, characterised in that the spatial light modulator is located outside the laser resonator between the optical pump source and the spectral selective element of the laser resonator, and the spatial light modulator is optically conjugated with the active element located inside the laser resonator.

Because the spatial light modulator is located beyond the limits of the laser resonator, the spatial modulation of the laser radiation is provided without the introduction of considerable losses into the laser resonator, and without any essential increase of the power intensity of radiation acting on the spatial modulator. There are thus provided an increase in the laser projector efficiency and an increase in the brightness of the image being projected.

A sufficiently low “black level” in the image being generated is achieved because a decrease of the laser pump level below a certain threshold value leads to a full suppression of the generation of laser radiation. Such a decrease of the pump level below the threshold value is able to be provided comparatively easily with the use of normal spatial light modulators.

The laser projector may be one in which a non-linear optical element, which is optically conjugated with the active element, is located in the laser projector between the active element and the means for laser radiation output from the resonator in order to convert the frequency of laser radiation being generated by the active element The introduction of such a non-linear element allows the expansion of the spectral range of the radiation being projected.

The laser projector may include laser resonator mirrors, and at least one of the laser resonator mirrors can be made in the form of a matrix of areas reflecting laser radiation, been which gaps are made with a decreased laser radiation reflection factor, and in which each of the areas is optically conjugated with a corresponding spatial modulator cell generating one pixel of the image being projected. Such an arrangement of one or several resonator mirrors impedes the blooming of bright pixel images.

The active element of the laser resonator can be made, for example in the form of a porous glass or polymer matrix, with an organic dye being introduced into the porous glass or the polymer matrix. The use of organic dyes as an active medium allows the avoidance of the appearance of speckles in the image being generated. The speckles appear as a spotty structure in the image, impairing the quality of the image. The speckles are caused by interference effects arising from coherent light scattering on diffuse surfaces. The avoidance of the speckles using the organic dyes is achieved because dye lasers are characterised by a sufficiently large width of the radiation spectrum, which substantially increases the spectrum width of gas lasers, metal vapour laser or solid-state lasers. Organic dye lasers can effectively generate radiation in the red, green and blue parts of the visible spectrum, which allows the creation of a full-colour laser projection based thereon.

The active element of the laser projector can be made in the form of a set of cells containing an amplifying medium and separated by areas with the absorbing or scattering medium. The construction may be, for example, in the form of a micro-channel plate, into which channel an organic dye liquid solution has been introduced. The set of cells containing the amplifying medium and separated by areas filled with absorbing or scattering medium impedes the radiation spreading in a direction which is perpendicular to the resonator axis. This provides suppression of the amplified spontaneous emission, decreasing the laser efficiency in the active element.

The laser projector may include a plate containing an active medium, and in which the plate is displaceable in a plane perpendicular to the laser resonator axis, so that a part of the plate inside the resonator forms the active element. The plate displacement in the plane perpendicular to the laser resonator axis contributes during projector operation to an increase of the effective volume of the active element interacting with pump radiation. The plate displacement also contributes to better cooling of the active medium, and thus to an extension of the laser projector service life and a decrease of thermally induced distortions of the wave front of the radiation being generated.

Embodiments of the invention will now be described solely by way of example and with reference to the accompanying drawings in which:

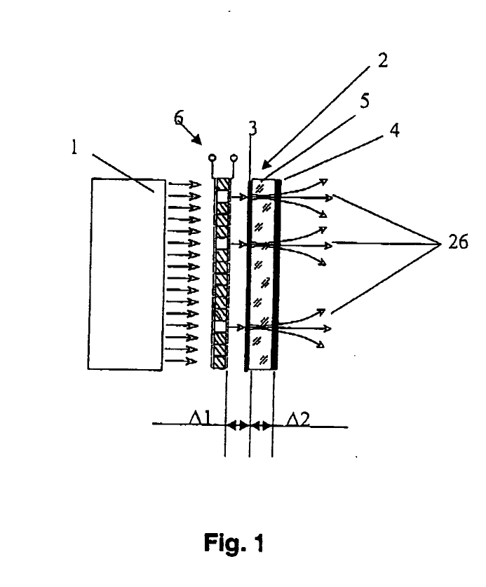

FIG. 1 schematically shows a first laser projector in accordance with the invention;

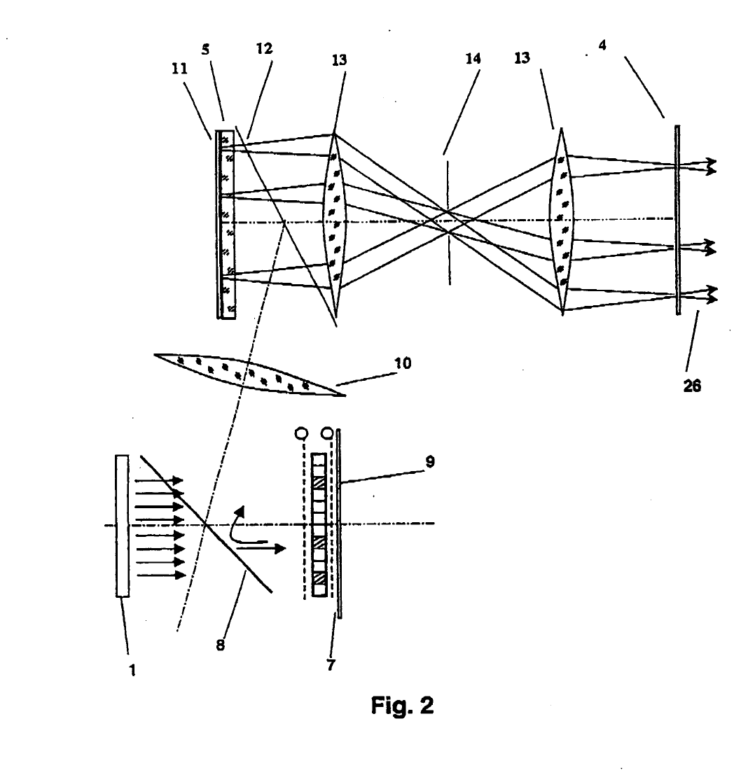

FIG. 2 shows a second laser projector in accordance with the invention;

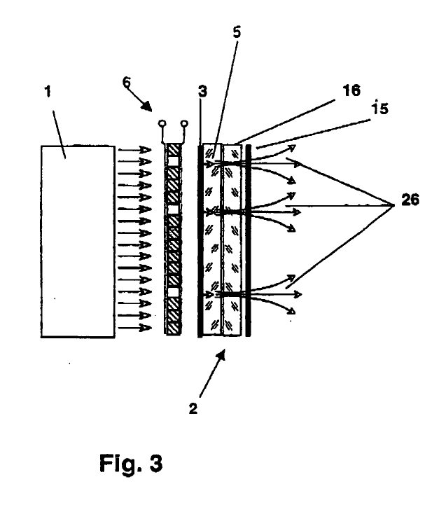

FIG. 3 shows a laser projector modification made in accordance with the invention;

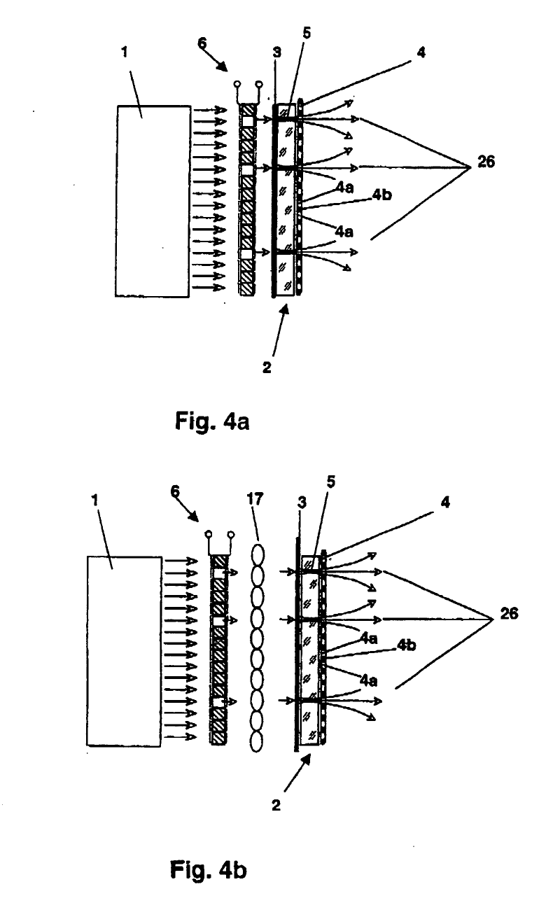

FIG. 4a and 4b show other laser projector modifications made in accordance with the invention;

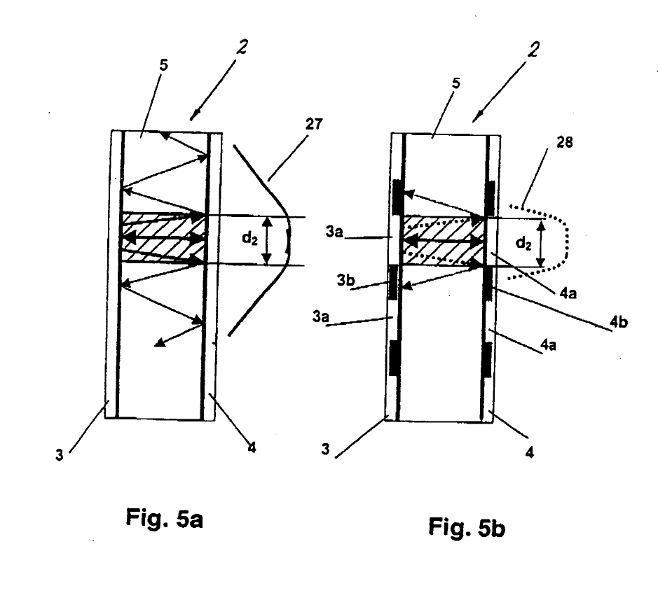

FIG. 5a and 5b explain one embodiment of an active element of the laser projector in accordance with the invention;

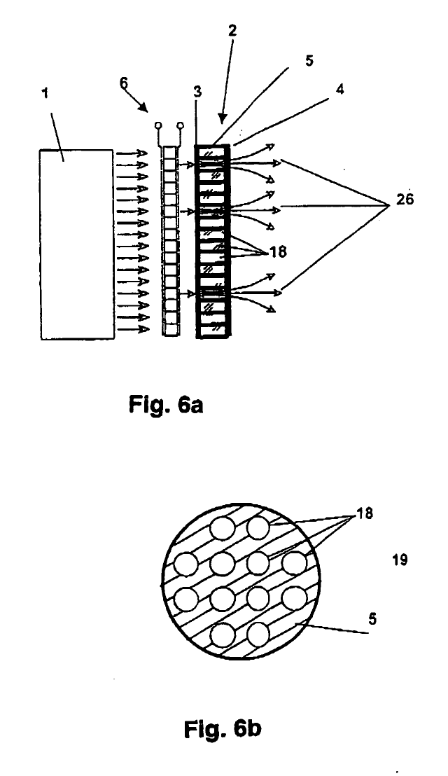

FIG. 6a shows another laser projector modification made in accordance with the invention;

FIG. 6b is a side view of the active element of the laser projector shown in FIG. 6a;

FIG. 7 shows another laser projector modification made in accordance with the invention;

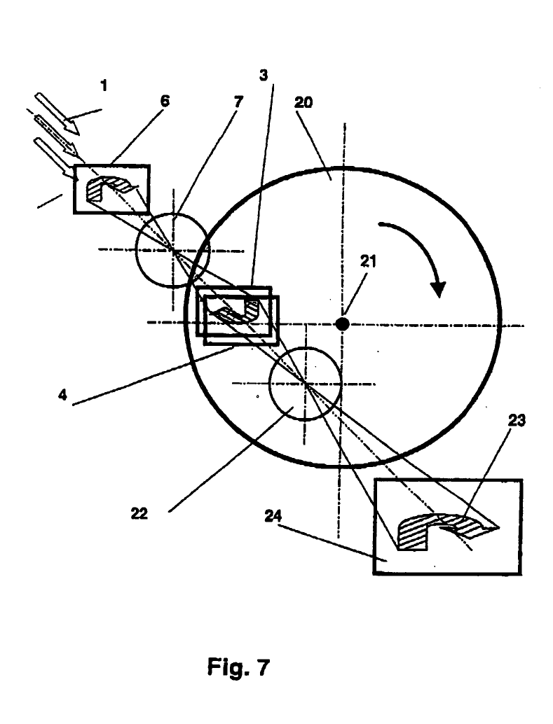

FIG. 8 shows an optical arrangement of an experimental laser projector made according to the invention;

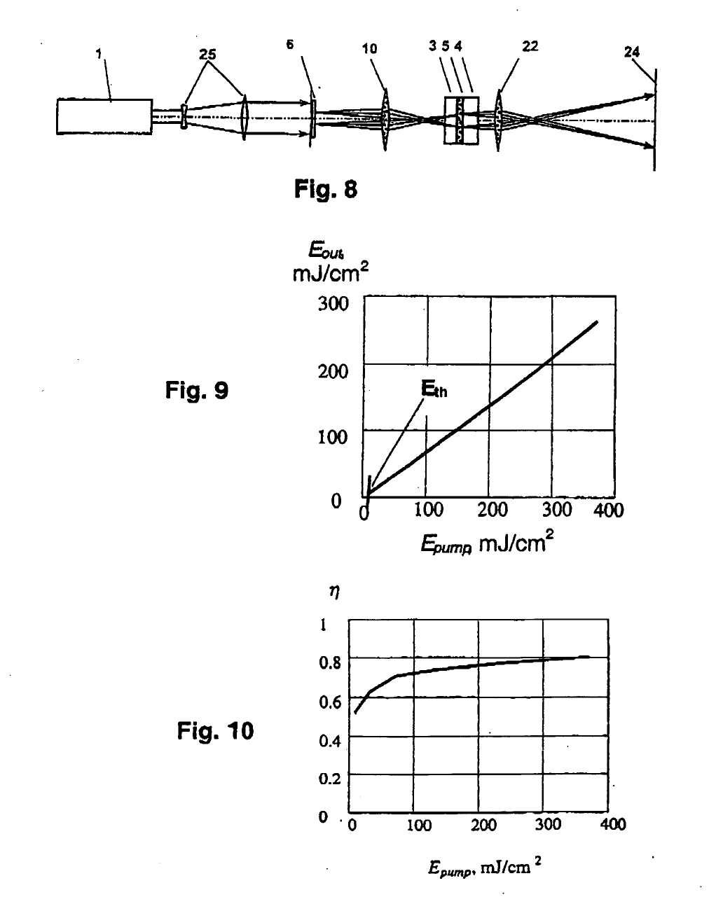

FIG. 9 show the experimentally-obtained dependencies of the output power density of the experimental laser projector shown in FIG. 8; and

FIG. 10 shows the efficiency of the active element of the laser projector upon the pump power of the experimental laser projector shown in FIG. 8.

In FIGS. 1-10 elements performing similar functions have been given the same reference numbers for ease of comparison and understanding.

Referring to FIG. 1, there is shown a projector comprising optical pump source 1 and a laser resonator 2. The laser resonator 2 is formed by a dichroic mirror 3 and a semitransparent mirror 4, between which an active element 5 is located. The optical pump source 1 may be, for example, laser diode lines, two-dimensional laser diode arrays or any other suitable sources of coherent or non-coherent light, such for example as gas-discharge, arc or pulse lamps, normally being used for optical laser pumping.

The dichroic mirror 3 has a high reflection factor for the wavelengths of radiation being generated by the laser resonator 2, and a high transparency for pump radiation. Thus, the dichroic mirror 3 performs the functions of a spectral selective element providing the input of pump radiation inside the laser resonator 2. The dichroic mirror 3 can be made by a known method in the form of a transparent substrate with a multi layer interference coating. The semitransparent mirror 4 provides a facility for the laser radiation output from the resonator 2.

A spatial light intensity modulator 6 is located between the optical pump source 1 and the dichroic mirror 3, and outside the laser resonator 2. The spatial modulator 6 is optically conjugated with the active element 5 located inside the laser resonator 2. In other words, the spatial modulator 6 is so located with respect to the active element 5 that the spatial modulator 6 generates a two-dimensional image in the plane of the active element 5. The spatial modulator 6 can be made by a known method, for example on the basis of a two-dimensional liquid-crystal matrix. Such a matrix may contain a transparent lamellate structure including a liquid-crystal layer modulating the polarisation of light passing through it, and a control layer based on a structure providing control of the distribution of electrical potential over the liquid-crystal layer of surface and a polariser. The electrical signal of an image providing generation of the electrical potential distribution over the liquid-crystal layer surface in accordance with the required image is supplied to the control layer of such a spatial modulator 6. Anisotropic molecules of the liquid-crystal layer are differently oriented under the influence of different local electrical potential. The polarisation of light being transmitted through the liquid crystal layer changes depends upon the orientation of the anistropic molecules. The subsequent transmission of the light with the spatially modulated polarisation through the polariser provides the spatial light intensity modulation, in accordance with the required image. The spatial modulator 6 can alternatively be of another structure, providing the spatial modulator 6 provides the spatial light intensity modulation at the transmission of light through the spatial modulator 6 or at the light reflection from the spatial modulator 6.

The optical conjugation of the spatial modulator 6 and the active element 5 in the laser projector shown in FIG. 1 are provided by their layout in the near vicinity of each other. The distance Δ₁ between the spatial light modulator 5 and the active element 2 should not be more than Δ₁=d₁²/λ₁, where d₁ is the diameter (minimal size) of the image element being generated by the spatial fight modulator and λ₁ is the pump radiation wavelength.

The active element 5 is located inside the laser resonator 2 so that the optical radiation from the pump source 1 passed through the dichroic mirror 3 should fall on the active element 5 and be absorbed in the active element 5. The active element thickness Δ₂ (thickness of the amplifying layer in the resonator) is normally selected from the condition of provision of the required resolution:Δ₂=d₂²/λ₂, where d₂ is the diameter of the image element being generated by the laser and λ₂ is the laser radiation wavelength.

In the example of the laser projection realisation shown in FIG. 2, a spatial modulator 6 of the reflective type is used. The spatial modulator 6 includes a liquid-crystal matrix 7, the spatially modulating polarisation of light passing through it. A polarisation beam splitter 8 is located between a pump source 1 and the liquid-crystal matrix 7. A mirror 9 is located behind the matrix 7. The polarisation beam splitter 8 is a plate having a reflection/transmission factor which is determined by the polarisation of incident radiation. Such a polarisation beam splitter 8 can be made by a known method, for example with the use of multi layer interference coatings. The optical conjugation of the spatial modulator 6 and the active element 5 are achieved in the embodiment of FIG. 2, unlike that shown in FIG. 1, by means of an objective 10 located in the optical path between the spatial modulator 6 and the active element 5. This objective 10 projects the image being generated by the spatial modulator 6 on the plane of the active element 5. The term “the plane of the active element 5” means the central plane of the active element being equally distant from its end faces. The parameters of the objective 10 can be chosen, for example, so that the image being projected on the active element 5 is demagnified as compared with the image being generated by the liquid-crystal matrix 7.

The laser resonator 2 in FIG. 2 is generated by a fully reflecting mirror 11 and a semi-transparent output mirror 4. The spectral selective element for the input of pump radiation inside a laser resonator 2 is in the form of a dichroic mirror 12 located inside the laser resonator 2, at an angle in respect of its axis. The dichroic mirror 12 has a high reflection factor for pump radiation wavelengths but is practically transparent for the wavelengths of the radiation being generated by the laser resonator 2.

Inside the laser resonator 2, as shown in FIG. 2, lenses 13 can additionally be located. A diaphragm 14 can be installed between the lenses 13. The pair of lenses 13 in FIG. 2 form an intra-resonator objective which mutually projects the planes of mirrors 4 and 11 into each other. The parameters of this intra-resonator objective can be selected, for example so that the image being projected on the output mirror 4 is enlarged as compared with the image being projected on the active element 5.

In the laser projector modification shown in FIG. 3, a non-linear optical element 16 is located between an active element 5 and an output mirror 15 of the laser resonator. The non-linear optical element 16 is optically conjugated with the active element 5 and serves to convert the frequency of laser radiation that is generated by the active element 5. The non-linear optical element 11 can be, for example, a plate of potassium thiophosphate or any other material with nonlinear optical properties. The plate is cut at a synchronism angle for the generation of the second (or any other) harmonic. The plate is adjacent to the active element 5 on one of its sides and to the output mirror 15 on its other side, as shown in FIG. 3. The output mirror 15 is preferably a dichroic mentor having a high reflection factor for the wavelength of radiation generated by the active element 5, and having a high transparency for the laser radiation being generated by the non-linear optical element 16 with the converted frequency, for example, for the second harmonic of the radiation generated by the active element 5.

In other laser projector modifications shown in FIG. 4a and 4b, a output semi-transparent mirror 3 of a laser resonator 2 is made in the form of a matrix of areas 4a reflecting laser radiation. The gaps 4b between the areas of 4a are made with a decreased laser radiation reflection factor, i.e. the gaps 4b are characterised by a higher transmission factor or a higher laser radiation absorption factor than the areas 4a. Each of the areas 4a is optically conjugated with the corresponding cell of a spatial modulator 6 generating one pixel of the image being projected. This optical conjugation can be made either by means of a close location of the spatial light modulator 6 to the dichroic mirror 3, as shown in FIG. 4a, or by placing a microlens matrix 17 between the spatial modulator 6 and the minor 3 as shown in FIG. 4b. The focal distance of the lenses and the pitch of the matrix 17 are selected so that the pump radiation passing through pixels of the spatial light modulator 6 are focused in a plane containing the active element 5.

In other versions of the invention, the above mentioned pixel-type structure can belong to any of the mirrors comprising the resonator 2. FIG. 5b shows in more detail a part of the laser resonator 2, in which both mirrors 3 and 4 forming the laser resonator 2 have the pixel-type structure. In other words, the dichroic mirror 3 of the laser resonator 2 is made in the form of a matrix of areas 3a reflecting laser radiation, which areas 3a are located opposite the areas of 4a of the opposite mirror 4, and the gaps 3b between the areas of 3a are made with a decreased reflection factor.

As shown in FIG. 6a and 6b, an active element 5 can be made in the form of a set of cells 18 containing the medium amplifying laser radiation and separated by areas 19 with the medium absorbing or scattering laser radiation. The active element 5 may be made in the form of a micro-channel plate with channels filled with a liquid solution of an organic dye. The minimum thickness of the plate is limited on the basis of effective absorption of pump radiation. The maximum thickness of the plate is limited on the basis of the required resolution. The channel diameter D can be chosen from the ratio: kD<2, where k is the amplification factor in the active element corresponding to the brightest pixels in the image, i.e. to the maximal value of the pump power being supplied to the active element For example, with a value of k of about 10÷50 cm″1, the diameter of channels of the microchannel plate can be equal to 0.4÷2 mm. In order to increase the laser service life and to reduce thermally-induced deformations of the active element, the laser projector can be equipped with facilities (not shown) for pumping a liquid organic dye solution through the microchannel plate.

The active element 5 can also be made in the form of a porous glass or polymer matrix with an organic dye being introduced into it. The polymer may be, for example, a polymethylmethacrylate. The organic dye may be, for example, Rodamin 6G.

The active element 5 can be made with a possibility of it driving in a plane perpendicular to the axis of the resonator 2. For example, as is shown in FIG. 7, the active element can be formed by a part of a plate 20, This part of the plate 20 is in the laser resonator, between a dichroic mirror 3 and a semi-transparent mirror 4. This part of the plate 20 contains the active medium and it is installed with the possibility of rotation around an axis 21 in the plane being perpendicular to the laser resonator axis. By way of example, the rotational movement of the plate 20 is shown. However, reciprocal movement, spiral movement, etc. of the plate 20 are also possible.

In FIG. 7, the objective projecting the plane of the spatial modulator 6 on the active element plane is denoted by the position 7, and the objective projecting the image 23 being generated by the laser projector on the external screen 24 is denoted by the position 22.

In order to create a laser projector for colour images, three laser projectors can be used in order to generate laser radiation of the three basic colours. The images can then be projected onto a common screen. Each projector, or at least one of the projectors, is made the same as described above. As the active medium of the projector designed for the generation of blue visible spectrum, one can use, as the active medium, ethanol solutions of coumarin dye, for example Coumarin 30 or Coumarin 314. As the active medium for the generation of red radiation, one can use an ethanol solution of a DCM dye. In order to obtain green radiation, one can use a solution of Coumarin 153 dye in ethanol. However in the present invention, in order to create a laser projector of colour images, other known methods for the generation of colour images by means of lasers may be used.

FIG. 8 shows a optical arrangement of a laser projector made according to the invention, which may be used to verify the principles of the present invention. In FIG. 8, lenses forming an expanding telescope designed for the generation of a pump radiation beam of a required lateral size are denoted by reference numeral 25. The remaining parts of the laser projector are described above.

For laser projector operation, the pump radiation (which is shown by arrows in FIG. 1) from the optical pump source 1 is supplied on a spatial light modulator 6. On the spatial light modulator 6, a modulating electrical signal is fed carrying information about the brightness of pixels of the image being projected. In accordance with this signal, the transmission factor of the corresponding modulator pixels is set so that the spatial radiation distribution is formed, which corresponds to the image being projected. In FIG. 1, the pixels of the modulator 6 are in the open state and are shown non-crosshatched. The crosshatched pixels are in the closed state. Thus the pump radiation is spatially modulated in the modulator 6 by the image being projected, after which it falls on the dichroic minor 3 of the resonator 2 and is transmitted by the dichroic mirror 3 to the active element 5. The active element 5 the laser resonator 2 absorbs the optical pump radiation and generates the forced radiation shown by the arrows of 26. The density of the pump power absorbed determines the density of the forced radiation power and thus the level of the brightness of pixel luminance in the image being generated. As shown in FIG. 1, in the cross-section areas of the active element 5 being optically conjugated with pixels of the modulator 6 in the open state, the amplification in the active element 5 exceeds losses of the resonator 2 and laser radiation is generated. For the remaining areas of the active element 5, the threshold condition is not met and the generation of the laser radiation does not occur. The generated radiation 20 is spatially modulated by the projected image and is therefore emitted through the output mirror 4 of the resonator 2, and then through the optical system 22 of the laser projector, where it fails on the external screen 24 as shown in FIGS. 7 and 8.

Thus the optical pump radiation supplied to the active element 5 of the laser is spatially modulated by a projected image. This leads to the corresponding modulation of the intensity of laser radiation being generated, which is projected on the external screen 24.

Even a fully open pixel of the real spatial modulator introduces some optical losses, which cannot be made equal to zero. These initial losses at the location of the spatial modulator 6 between the pump source 1 and the laser resonator 2 lead to a certain decrease of power of the pump radiation falling on the active element 5. This in turn leads to a corresponding reduction of the maximum power of the laser radiation being generated. However, as compared with the intra-resonator image generation method, when the spatial modulator is located inside the laser resonator and the laser radiation is generated at its multiple passing through the resonator passes multiply through the modulator, in the proposed projector, the influence of the above-mentioned losses in the open pixel of the modulator on the laser radiation power considerably decreases because the pump radiation passes only once through the modulator.

In addition, the density of the flux of energy accumulated inside the laser resonator 2 at the generation of laser radiation, multiply exceeds the density of the pump radiation energy flux supplied to the active element 5, and the resistance of the spatial modulator against the action of laser radiation is normally considerably less than that for the elements forming the laser resonator 2. Therefore, the location of the spatial modulator 6 outside the laser resonator 2 significantly reduces the requirements for the laser resistance of this spatial modulator 6, or allows the supply a considerably higher pump radiation power to the laser resonator 2 than at the location of a similar modulator inside the resonator 2.

Thus in the laser projector of the invention, the spatial modulation of laser radiation is carried out without introduction of considerable losses into the, laser resonator and without significant increase of the density of power of radiation acting on the spatial modulator. This provides an increase of the efficiency and a maximum brightness of radiation as compared with a projector using the intra-resonator image generation method. At the same time, as the reduction of the optical pump radiation level below the threshold value leads to the full suppression of the generation of laser radiation from the corresponding area of the active element 5, a sufficiently low (practically zero) “black level” is provided in the image being generated. This is unlike those projection devices where the spatial modulator is placed between the laser resonator and the projection screen.

As an alternative to the spatial modulation, the modulator 6 can provide time modulation of pump radiation. For example, for the generation of a moving image, the modulator 6 can generate a sequence of image frames with the given repetition frequency, or the modulator 6 can generate an image in parts, by means of any suitable image generation method, for example by means of a non-interlaced scan.

In the laser projector shown in FIG. 2, radiation from the pump source 1 enters onto the liquid-crystal matrix 7 of the spatial modulator 6 via the polarisation beam splitter 8. Then the pump radiation passes through cells of the matrix 7, reflects from the mirror 9, repeatedly passes through the cells of matrix 7 in the reverse direction and then again comes to the beam splitter 8 on its other side. The control of the matrix 7 is carried out so that the phase shift between two orthogonal states of the polarisation of radiation having passed through the matrix cell is determined by the required brightness of the pixel of the image being generated, which correspond to this cell. As the reflection factor of the beam splitter 8 is determined by the above mentioned phase shift in the incident radiation, the radiation with the spatially modulated polarisation generated by the matrix 7 is converted, as a result of reflection from the beam splinter 8, into radiation with spatially modulated intensity, This spatially modulated pump radiation is reflected from the beam divider 8 in the direction of the objective 10 and is projected by the objective 10 to the plane of the active element 5, with the reflection of the dichroic mirror 12.

In the laser projector shown in FIG. 2, the location of the modulator 6 at a distance from the active element 5 enables the use of a spatial modulator 6 of the reflective type. In such a spatial modulator 6, the pump radiation passes twice through the liquid-crystal matrix 7. The double passing of the pump radiation through the matrix 7 allows the provision of the required phase incursion between orthogonal polarised components of the pump radiation at a lower control voltage on the matrix 7. In addition, due to the use of the objective 10 for the optical conjugation of the modulator 6 and the active element 5, the structure shown in FIG. 2 enables scaling of the image being generated in the plane of the active, element 5. Normally, it is preferable to reduce the image generated on the active element 5 as compared with dimensions of the matrix 7. This is because the pump power density value, which is optimal for the active element, is, as a rule, greater than the power density value being endured by the liquid-crystal modulator matrix without destruction.

The location of the lenses 13 inside the laser resonator 2 provides a possibility of changing the mutual scale of images on the mirrors 11 and 4. Thus the image being generated on the output mirror 4 can be enlarged as compared with the image on the mirror 11, i.e. on the active element 5. The availability of the diaphragm 14 inside the resonator 2 allows the limitation of the width of the spatial spectrum of the radiation being generated in order to reduce the noise level in the image being generated.

In the laser projector shown in FIG. 3, the non-linear optical element 16 which is installed between the active element 5 and the output mirror 15 provides conversion of the frequency of amplified radiation being generated by the active element 5, for example the multiple multiplication of this frequency or any other type of non-linear conversion. For example, the non-linear optical element 16 in the form of a plate from the KTP crystal cut at the angle of synchronism for the generation of the second harmonic, provides, at the passing of laser radiation through it generated by the active element 5, the generation of the second harmonic of this radiation. The radiation of this harmonic emits from the laser resonator 2 through the dichroic mirror 15 being transparent for this harmonic and forms an image being generated by the laser projector. The use of such projection design gives the possibility of a broader choice of the type of the laser's active medium, because the frequency of output radiation of the laser projector can, for example, be significantly higher than the frequency of amplified radiation of the active element 5.

In the laser projector modifications shown in FIG. 4a and 4b the semi-transparent mirror 4 of the resonator 2 is made pixel-type A part of the laser radiation generated by the pixel, having a wave front inclined in respect of the resonator axis, falls, after reflecting from the mirror 3, on the gaps 4b between the reflecting areas 4a. The gaps 4b have a high transmission factor or an increased absorption factor of the laser radiation. This part of the radiation is either absorbed by the gaps 4b or is transmitted by the gaps 4b outside in the near vicinity of the generating pixel. This prevents further spreading of this part of the radiation over the laser resonator 2 in the crosswise direction, and thus impedes the blooming of images of bright pixels.

In order to explain the above, the beam path and the distribution of the field in the resonator 2 with solid and pixel-type mirrors respectively are shown in FIG. 5a and 5b. In the resonator 2 with solid mirrors 3 and 4, as shown in FIG. 5a, the light spreading at an angle to the resonator axis can move away for a considerable distance from the pixel generating it over a zigzag trajectory by means of consecutive reflections from the mirrors 3 and 4. This leads to the generation of a field distribution as shown by curve 27. The width of the field distribution significantly exceeds the crosswise size of d₂ of the radiation generation area. In the resonator with the pixel-type mirrors (FIG. 5b), the fight falling on the gaps 3b or 4b is absorbed by the resonator, or comes out from the resonator 2 outside. Thus the right does not spread over the resonator 2 in a crosswise direction for a considerable distance. Thus, in the resonator 2 With pixel-type mirrors 3 and 4 (or at least with one such mirror), a significantly narrower field distribution is provided (curve 28) than in the resonator 2 with solid mirrors.

A version of the active element 5 in the form of a set of cells 18 containing the medium amplifying radiation, as shown in FIG. 6a and 6b. More specifically, FIGS. 6a and 6b show the active element 5 in the form of a micro-channel plate, with channels filled by a liquid organic dye solution. This construction impedes the spreading of radiation in a direction perpendicular of the axis of resonator 2. This in turn excludes the appearance and development of amplified spontaneous emission, which reduces the laser efficiency. The use of organic dyes as the active medium allows the avoidance of the speckles in the laser image, as dye lasers have a sufficiently broad radiation spectrum. The use of organic dyes also gives an opportunity to generate laser radiation in the red, green and blue visible spectrum, which allows the creation of full-coloured laser projector based thereon. The pumping of the liquid organic dye solution through the microchannel plate contributes to the extension of the life of the laser, and also contributes to a reduction of thermally induced deformations of the active medium.

In the laser projector shown in FIG. 7, the plate 20 is driven during the projector operation into rotation around the axis 21 by a motor (not shown). The active element 5 of the laser resonator 2 is formed by that part of the plate 20 which is inside the resonator 2, i.e. between the mirrors 3 and 4 forming the optical resonator. The rotation provides periodic change of the areas of plate 20 generating radiation. This in turn provides an increase of the volume of active medium interacting with the pump radiation and better cooling, which contributes to the extension of the laser projector service and to the reduction of thermally induced distortions of the wave front of the radiation being generated. The increase of the active medium volume leads to a decrease of the mean exposure dose of dye irradiation, and this additionally contributes to the life of the projector.

FIG. 9 and 10 respectively show the dependencies of the output energy density Eₒᵤₜ and the laser efficiency (η) upon the pump energy density Eₚᵤₘₚ, obtained by means of the laser projector shown in FIG. 8. As shown in FIG. 9, the laser projector really has a threshold pump level (Eₜₕ) below which the laser radiation generation completely stops. This guarantees a practically zero “black level” in the image being generated by the projector. The behavior of the dependency of the output energy density upon the pump energy density is close to linear, and this facilitates the obtaining of a “grey” scale in the image being generated. FIG. 10 demonstrates a high (up to 80%) effectiveness of the pump energy conversion into the energy generation energy in the laser projector.

It is to be appreciated that the embodiments of the invention described above with reference to the accompanying drawings have been given by way of example only and that modifications may be effected.

1. A method of laser projection of images, which method comprises supplying optical pump radiation on an active element of the laser in order to generate laser radiation, spatially modulating of the intensity of laser radiation being generated by the active element by the image being projected, and projecting spatially modulated laser radiation onto a screen, characterised in that the spatial modulation of the laser radiation intensity is carried out by means of the spatial modulation of the power of optical pump radiation being supplied to the active element of the laser.

2. A laser projector for projecting images, which projector comprises a pump source for the generation of pump radiation, a spatial light modulator, a laser resonator including a spectral selective element for the input of pump radiation inside the laser resonator, an active element located inside the laser resonator, and means for the output of laser radiation from the laser resonator being generated therein, characterised in that the spatial light modulator is located outside the laser resonator between the optical pump source and the spectral selective element of the laser resonator, and the spatial light modulator is optically conjugated with the active element located inside the laser resonator.

3. A laser projector according to claim 2 in which a non-linear optical element which is optically conjugated with the active element is located between the active element and the means for laser radiation output from the resonator, in order to convert the frequency of laser radiation being generated by the active element.

4. A laser projector according to claim 2 and including laser resonator mirrors, and in which at least one of the laser resonator mirrors is made in the form of a matrix of areas reflecting laser radiation, between which gaps are made with a reduced laser radiation reflection factor, and in which each of the areas is optically conjugated with a corresponding cell of the spatial modulator generating one pixel of the image being projected.

5. A laser projector according to claim 2 in which the active element is a porous glass or polymer matrix, with an organic dye being introduced into the porous glass or the polymer matrix.

6. A laser projector according to claim 2 in which the active element is made in the form of a set of cells containing an amplifying medium separated by areas with an absorbing or scattering medium.

7. A laser projector according to claim 6 in which the active element is a micro-channel plate having channels containing a liquid organic dye solution.

8. A laser projector according to claim 2 and including a plate containing an active medium, and in which the plate is displaceable in a plane perpendicular to the laser resonator axis so that a part of the plate is inside the resonator and forms the active element.
